(19) United States
(12) Patent Application Publication
(10) Pub. No.: US 2002/0003456 A1
(43) Pub. Date: Jan. 10, 2002

(54) ANTENNA DUPLEXER AND COMMUNICATION APPARATUS

(76) Inventors: HITOSHI TADA, ISHIKAWA-KEN (JP); MOTOHARU HIROSHIMA, ISHIKAWA-KEN (JP); HIDEYUKI KATO, ISHIKAWA-KEN (JP)

Correspondence Address: JAMES A FINDER, OSTROLENK FABER GERB & SOFFEN LLP, 1180 AVENUE OF THE AMERICAS, NEW YORK, NY, 100368403

(21) Appl. No.: 09/382,838

(22) Filed: Aug. 25, 1999

(30) Foreign Application Priority Data
Aug. 25, 1998 (JP) 10-238821

(51) Int. Cl. H01P 1/202; H01P 7/04

(52) U.S. Cl. 333/134; 333/206; 333/222

(57) ABSTRACT

There is provided an antenna duplexer, comprising: a plurality of resonance electrodes constituting a transmission filter and a reception filter; a dielectric member disposed betwee:n the resonance electrodes and a ground electrode; a transmission terminal, a reception terminal, and an antenna terminal, which are separated from the ground electrode in the region where the ground electrode is formed; at least one ol the transmission terminal and the reception terminal provided to make capacitive coupling between the resonance electrode of a first stage corresponding to ani In/Out stage and the resonance electrode of a second stage adjacent to the resonance electrode.

The above antenna duplexer is low-cost, compact, and satisfactory in the characteristics.

### BACKGROUND OF THE INVENTION

1. Field of the Invention

The present invention relates to an antenna duplexer, in which resonance electrodes forming a transmission filter and a reception filter are arranged inside a single dielectric block, inside a dielectric substrate, or on the dielectric substrate, and a communication apparatus incorporating the same.

2. Description of the Related Art

In antenna duplexers, a transmission filter and a reception filter are disposed. One of the filters needs a large amount of attenuation in the pass band of the other filter. Consequently, for instance, an arrangement is provided such that when the transmission filter is lower than the frequency of the reception filter, the transmission filter is formed to have an attenuation pole on the higher band side of the pass band, namely, on the pass-band side of the reception filter, whereas the reception filter is formed to have an attenuation pole on the lowerband side of the pass band, narriely, on the pass-band side of the transmission filter.

When such an antenna duplexer is formed integrally by a single dielectric block, conventionally, for example, a structure as shown in FIG. 9 has been adopted.

This antenna duplexer has a dielectric block 1. Inside the dielectric block are formed resonator holes 2a through 2c on the transmission-filter side, resonator holes 3a through 3c on the reception filter side, and an external coupling hole 4a, in which an inner conductor is formed on each inner periphery. A transmission terminal Tx, a reception terminal Rx, an antenna terminal ANT are formed on the external surface of the dielectric block 1, and an outer conductor is formed on the almost entire surface excluding these terminal-formed parts. Each resonator hole is formed by a step hole in which the inner diameters are different at an approximately intermediate part, and a non-conductive portion g is disposed near the edge of one end face on the inner conductor of each resonator hole to form an open end. The antenna terminal ANT is directly connected to the inner conductor of the external coupling hole, an external coupling (an io coupling) is obtained by making capacitive coupling between the transmission terminal Tx and the inner conductor of the resonator hole 2a and between the reception terminal Rx and the inner conductor of the resonator hole 3c, respectively.

In this antenna duplexer, the transmission filter is set to have a lower frequency than that of the reception filter. As indicated by broken lines in FIG. 4, with a combination of the coupling between the resonators by the step holes and the coupling between the resonators by eccentricities of the larger inner-diameter part and the smaller inner-diameter of the step hole, the structure of the dupixer is such that the coupling between the resonators of the transmission filter is set to be an inductive coupling so as to have two attenuation poles on the higher-frequency-side of the pass band, and the coupling between the resonators of the reception filter is set to be a capacitive coupling so as to have two attenuation poles on the lower-frequency sides of the pass band.

However, in the above conventional antenna duplexer, with either the transmission filter or the reception filter, sufficient attenuation cannot be obtained in the pass band of the filter as a counterpart. That is, when an attenuation pole is obtained only by the coupling between the resonators as described above, there is a limitation in setting and adjusting the pole frequency of the attenuation pole and the magnitude of the attenuation, so that it is difficult to obtain a required filter characteristic (attenuation characteristic).

Therefore, as shown in FIG. 10, an antenna duplexer is adopted, in which a trap resonator is also added into a single dielectric block. In this antenna duplexer, in addition to the structure shown in FIG. 9, resonator holes 2d and 3d for trapping and external coupiing holes 4b and 4c for making an IN/OUT coupling are additionally disposed on the transmission-filter side and the reception-filter side of the dielectric block 1, whereby the trap resonators corresponding to the resonator hole 2d and the resonator hole 3d respectively allow the attenuation characteristic in the pass band of the counter-part filter to be improved so as to obtain a required sufficient attenuation. In this structure, however, although the required characteristic can be obtained, a trap resonator and an external coupling hole are additionally necessary to be disposed, leading to upsizing of the antenna duplexer.

Furthermore, it is also possible to achieve improvement in the characteristic by using another filter or the like. However, in this case, another component and space for mounting the component are required, so that this leads to increase in cost, or upsizing of the over-all communication apparatus.

### SUMMARY OF THE INVENTION

To overcome the above described problems, preferred embodiments of the present invention provide an antenna duplexer and a communication apparatus, which are low-cost, compact, and satisfactory in the characteristic.

One preferred embodiment of the present invention provides an antenna duplexer, comprising: a plurality of resonance electrodes constituting a transmission filter and a reception filter; a dielectric member disposed between the resonance electrodes and a ground electrode; a transmission terminal, a reception terminal, and an antenna terminal, which are separated from the ground electrode in the region where the ground electrode is formed; at least one of the transmission terminal and the reception terminal provided to make capacitive coupling between the resonance electrode of a first stage corresponding to an In/Out stage and the resonance electrode of a second stage adjacent to the resonance electrode.

In the above described antenna duplexer, the coupling between the resonator of a first stage and the resonator of a second stage forming a filter of a lower frequency may be an inductive coupling, and the coupling between the resonator of a first stage and the resonator of a second stage forming a filter of a higher frequency may be a capacitive coupling.

In the above described antenna duplexer, a trap resonator may be added into the In/Out unit of either one ol the transmission filter or the reception filter.

In the above described antenna duplexer, at least one of the couplings between the resonators may be ari interdigital coupling.

In the above described antenna duplexer, the respective resonance electrodes may have a step-like configuration in which the line width is different at a certain point; and the step-likes configurations of the resonance electrodes are formed in such a manner that Ihe coupling between the adjacent resonators provides a required value.

In the above described antenna duplexer, the narrow part of the linewidth of the resonance electrode may extend off the wide part of the line-width.

In the above described antenna duplexer, the resonance electrode may be formed on the inner periphery of a resonator hole disposed inside the dielectric member.

In the above described antenna duplexer, the resonance electrode may be formed in a strip-line configuration inside the dielectric member or on the dielectric member.

In the above described antenna duplexer, at least one resonator hole or a part of the resonator hole may be in a quadrangular-sectional configuration.

Another preferred embodiment of the present invention provides a communication apparatus comprising at least one of the above described antenna duplexers.

In the antenna duplexer having the above-described structure, either the transmission terminal or the reception terminal is formed to make capacitive coupling between the resonance electrode of a first stage and the resonance electrode of a second stage. In this structure, an external coupling capacity is obtained by the capacity between each terminal and the resonance electrode of the first stage, and the pole frequency of an attenuation pole frequency can be changed by the capacity between each terminal and the resonance electrode of the second stage. Specifically, when the value of the capacity generated between each terminal and the resonance electrode of the second stage is set to be larger, the attenuation pole can be moved to be closer to the pass-band side. Accordingly, without disposing a trap resonator, or incorporating another component, the required attenuation characteristic can be easily obtained.

The coupling between the resonators of the first stage and the resonators of the second stage of the lower-lrequency filter is set to be an inductive coupling, and the coupling between the resonators of the first stage and the resonators of the second stage of the higher-frequency filter is set to be a capacitive coupling, in which an attenuation pole is provided on the pass-band side of the counterpart-side filter, respectively. Then, movement of the attenuation pole as described above allows the required amount of attenuation to be easily obtained within the pass band of the counterpart-side filter.

Additionally, the In/Out unit of one of the filters may have the structure of the present invention, whereas the In/Out unit of the other filter may have a structure in which a trap resonatcr is disposed. Various characteristics can be obtained by using the trap resonator together in the structure.

Furthermore, a part of the couplings between the resonators is set to be an interdigital coupling, whereby freedom in the coupling between the resonators can be enhanced so as to enhance Q^{O} of the resonators.

Furthermore, the coupling relationship between the adjacent resonators (either a capacitive coupling or an inductive coupling) and the coupling degree can be easily changed by forming the resonance electrode in a step-like configuration to change the configuration of the resonance electrode. Extracting the narrow part of the line width of the step resonance electrode off the wide part of the line width permits the coupling between the resonators to be adjusted in a wider range. In other words, there is no need to form a hole or a groove for coupling in the dielectric member in order to obtain the coupling between the resonators, so that a low-cost and compact antenna duplexer can be formed.

In addition, with the structure in which the resonator holes are made in the dielectric member and the resonance electrodes are formed on the inner periphery of the resonator holes, Q_{O} can be improved more than that of a strip-line type of resonance electrode, so that the insertion losses can be reduced.

Furthermore, the structures in which the resonance electrodes are formed in a strip-line configuration in the dielectric member permits the antenna duplexer i to be formed to be thinner (lower n height).

In the antenna duplexer according to the present invention, the transmission filter and the reception filter are formed integrally in the single dielectric member. Thus, compared with the one in which each filter is formed in a separate dielectric member, the number of components is reduced to make the production easier, so that the production cost and mounting cost are lowered.

Furthermore, since the ccmmunication apparatus according to the present invention is formed by disposing the antenna duplexer having the above-described characteristics, it is low-cost, compact, and satisfactory in the characteristics.

Other features and advantages of the present invention will become apparent from the following description of the invention which refers to the accompanying drawings.

### BRIEF DESCRIPTION OF THE DRAWINGS

FIGS. 1A, 1B and 1C show a structure of an antenna duplexer of a first embodiment, in which FIG. 1A is a back view, FIG. 1B is a plan view, and FIG. 1 C is a front view.

FIG. 2 is a sectional view of the antenna duplexer of the first preferred embodiment.

FIG. 3 is an equivalent circuit diagram of the antenna duplexer of the first preferred embodiment.

FIGS. 4A, 4B and 4C show graphs showing the attenuation characteristics of the antenna duplexer of the first preferred embodiment and a conventional antenna duplexer, in which FIG. 4A shows the characteristics of a transmission filter, and FIG. 4B shows the characteristics of a reception filter.

FIGS. 5A, 5B and 5C show, a structure of an antenna duplexer of a second preferred embodiment, in which FIG. 5A is a back view, FIG. 5B is a plan view, and FIG. 5C is a front view.

FIGS. 6A, 6B and 6C show a structure of an antenna duplexer of a third preferred embodiment, in which FIG. 6A is a back view, FIG. 6B is a plan view, and FIG. 6C is a front view.

FIGS. 7A, 7B and 7C shoiv a structure of an antenna duplexer of a fourth preferred embodiment, in which FIG. 7A is a back view, FIG. 7B is a plan view, and FIG. 7C is a front view.

FIG. 8 is a block diagram of a communication apparatus of a fifth preferred embodiment.

FIGS. 9A, 9B and 9C show a structure of a conventional antenna duplexer, in which FIG. 9A is a back view, FIG. 9B is a plan view, and FIG. 9C is a front view.

FIG. 10 is a plan view of a prior art antenna duplexer.

### DESCRIPTION OF THE PREFERRED EMBODIMENTS

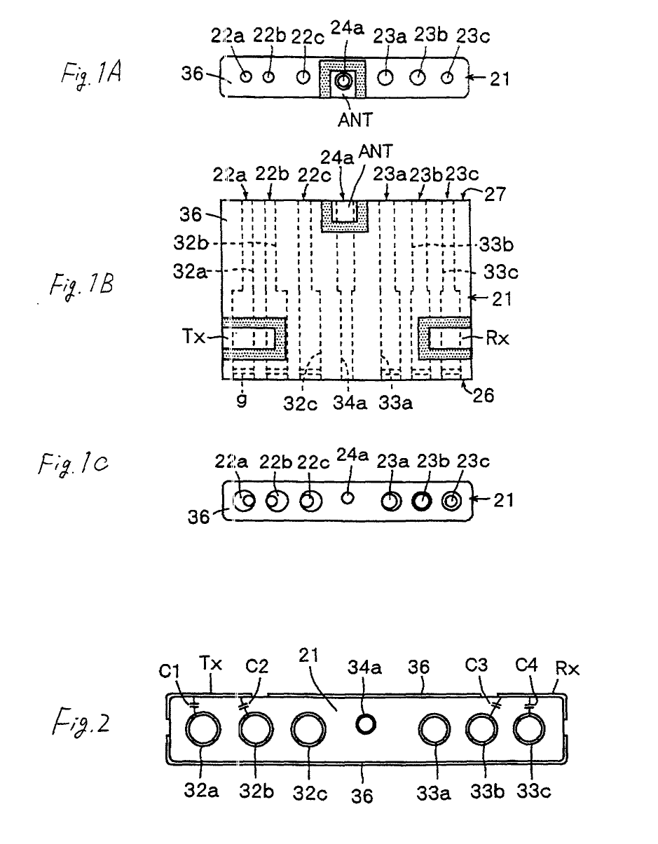

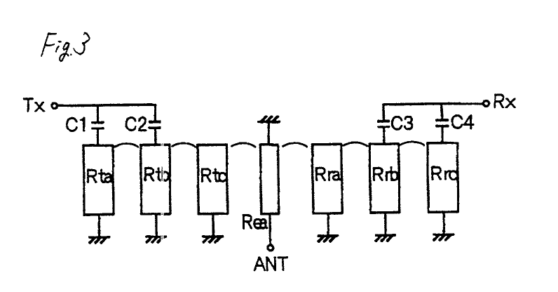

Referring to FIGS. 1A, 1B and 1C and FIG. 2, a description will be given of a structure of an antenna duplexer according to a first preferred embodiment of the present invention.

The antenna duplexer of this embodiment includes a band pass filter of three stages on the transmission side and a band pass filter of three stages on the reception side. In a dielectric block 21 of a rectangular-parallelepiped configuration are formed resonator holes 22a through 22c of the transmission-filter side, resonator holes 23a through 23c of the reception-filter side, and an external coupling hole 24a. The central frequency of the transmission filter is lower than that of the reception filler. The outline dimension is substantially 12.0 mm in width, 8.6 mm in length, ani 2.0 mm in thickness.

The resonator holes 22a through 22c, 23a through 23c, and the external coupling hole 24a, as shown in FIG. 1 (b), respectively pass through a first end face 26 of the dielectric block 21 to a second end face 27 opposing to the end face 26 and respectively have a step portion at the substantial center in the axial-center direction, in which they are step holes respectively having different inner diameters between the upper-half parts and the lower-half parts. On the inner wall surfaces of the respective resonator holes 22a through 22c, 23a through 23c, and the external coupling hole 24a are formed inner conductors 32a through 32c, 33a through 33c, and 34a, respectively. On the inner conductors 32a through 32c, a non-conductive portion g is disposed near the edge (the first end face 26) of the step hole with the large inner diameter (the large inner-diameter part) to form an open end. On the outer surface of the dielectric block 21 are formed a transmission terminal Tx, a reception terminal Rx, and an antenna terminal ANT, in which an outer conductor 36 is formed on the almost entire surface excluding the respective terminals Tx, Rx, aind ANT. The inner conductors 32a through 32c, 33a through 33c are connected tc the outer conductor 36 on the second end face 27 of the small-diameter side (the small inner-diameter part), which is opposing the open end, in which the second end face 27 is a short-circuited end. The respective inner conductors serve as resonance electrodes and the outer conductor 36 serves as a ground electrode, in which a coaxial resonator is each formed corresponding to the respective inner conductors.

The axes of the small inner-diameter part of the short-circuited end side of the resonator holes 2a through 2c on the transmission-filter side are formed by being eccentric with respect to the axes of the large inner-diameter part so that the axes are close to each other. With this arrangement, the coupling between the resonators corresponding to the inner conductors 32a, 32b, and 32c is set to be an inductive coupling so as to form two attenuation poles on the higher-frequency side of the pass band.

As for the coupling between the resonators corresponding to the inner conductors 33a through 33c, an original capacitive coupling by the step holes is used and the coupling between thie resonators is changed by eccentricity of the small inner-diameter part, and thie coupling between the resonators corresponding to the inner conductors 3c, 3b, and 3a is set to be a capacitive coupling so as to form two attenuation poles on the lower-frequency side of the pass band.

The antenna terminal ANT, being connected to the inner conductor 34a of the external coupling hole 24a, is formed by being extended from one of the main surfaces to the second end face 27. An interdigital coupling is made between the inner conductor 34aof the external coupling hole 24a and the inner conductors 32c and 33a adjacent to the inner conductor 34a, whereby an external coupling (the IN/OUT coupling) of an IN/OUT of each of the transmission filter and the reception filter is obtained.

The transmission terminal Tx is formed by being extended from one of the main surfaces to a side surface rear the open end of the transmission-filter side, in which a capacitive coupling is made between the inner conductor 32a of the first stage corresponding to the IN/OUT stage of the transmission filter and the adjacent inner conductor 32b of the second stage.

The reception terminal Rx is formed by being extended form one of the main surfaces to a side surface near the open end of the reception-filter side, in which a capacitive coupling is made between the inner conductor 33c of the first stage corresponding to the IN/OLIT stage of the reception filter and the adjacent inner conductor 33b of the secondi stage.

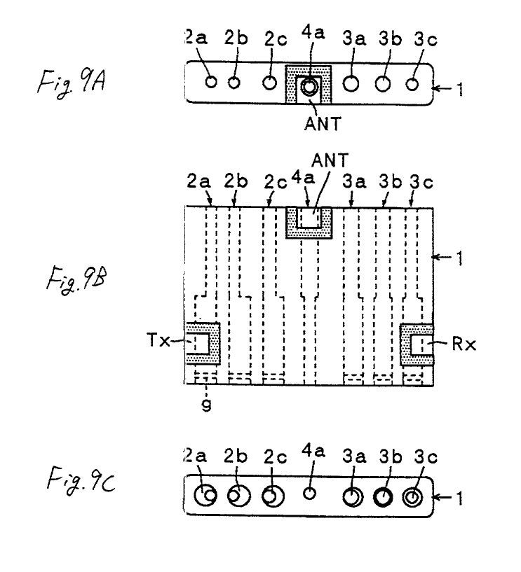

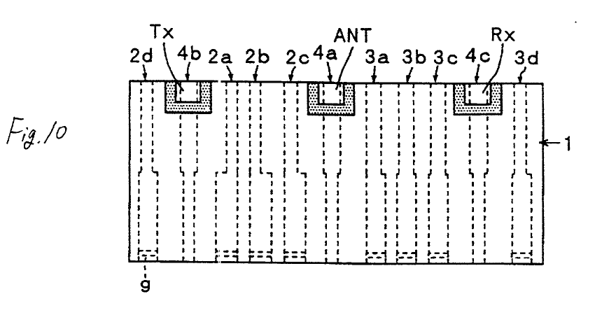

In other words, the transmission terminal Tx and the reception terminal Rx are respectively extended into the center direction further than the conventional one shown in FIG. 9 to be formed up onto the part opposing the inner conductors 32b and 33b.

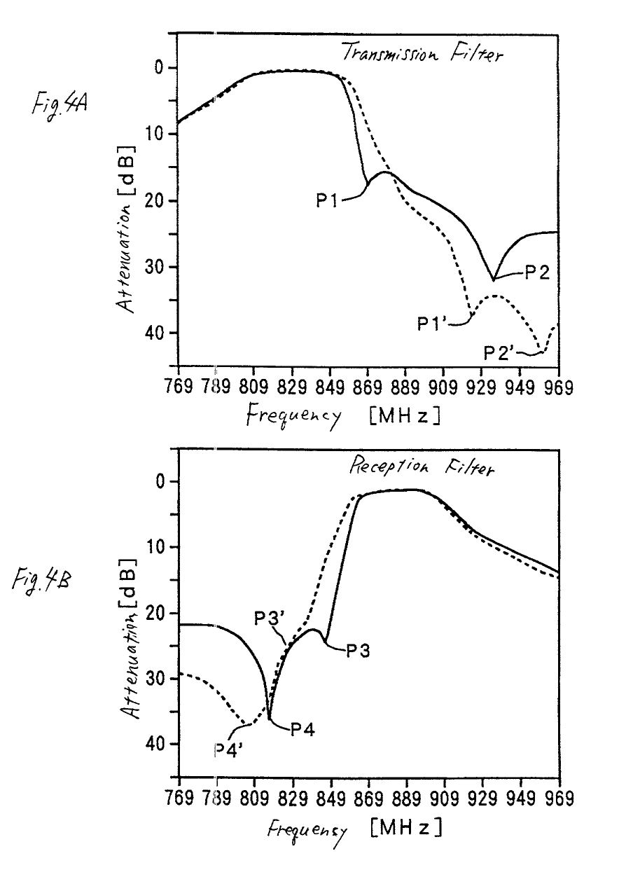

FIG. 2 is a sectional view passing through the transmission terminal and the reception terminal in FIG. 1B. However, hatching is omitted due to simplification of the drawing. FIG. 3 is an equivalent circuit diagram of the antenna duplexer above. In FIG. 3, Rta through Rtc are the resonators formed by the inner conductors 32a through 32c shown in FIGS. 1A,1B and 1C and FIG. 2, Rra through Rrc are the resonators formed by the inner conductors 33a through 33c, Rea is a resonator formed by the inner conductor 34a, and capacities C1 and C2 are the capacities respectively formed between the transmission terminal Tx and the inner conductors 32a and 32b shown in FIG. 2, whereas capacities C3 and C4 are the capacities respectively formed between the reception terminal Rx and the inner conductors 33b and 33c.

In this arrangement, the capacity Cl serves as the external coupling capacity of the transmission filter, and the capacity C4 serves as the external coupling capacity of the reception filter. The capacity C2 serves to change the pole frequency of an attenuation pole of the transmission filter, and the capacity C3 serves to change the pole frequency of an attenuation pole of the reception filter.

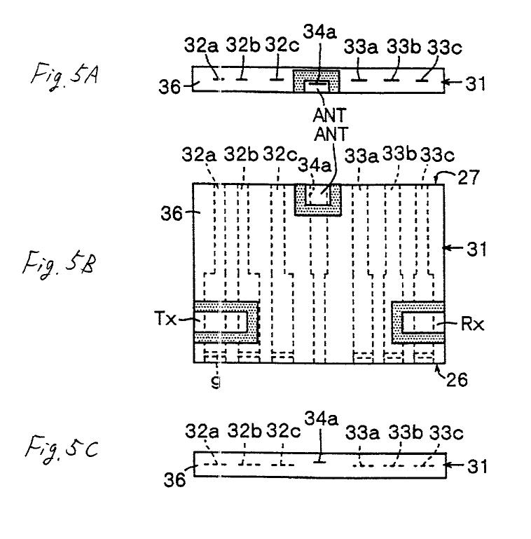

FIGS. 4A and 4B are views of the attenuation characteristics of the abovedescribed antenna duplexer. FIG. 4A shows the characteristics of the transmission filter, and FIG. 4B shows the characteristics of the reception filter. In addition, solid lines indicate the characteristics of the embodiment, and broken lines indicate the characteristics of the conventional antenna duplexer shown in FIGS. 9A, 9B and 9C. In FIGS. 4A and 4B, P1 and P1' indicate the attenuation poles obtained by the inductive coiupling between resonators Rtaand Rtb, P2 and P2' indicate the attenuation poles obtained by the inductive coupling between resonators Rtb and Rtc, P3 and P3' indicate the attenuation poles obtained by the capacitive coupling between resonators Rrc and Rrb, and P4 and P4' indicate the attenuation poles obtained by the capacitive coupling between resonators Rrb and Rra.

As shown in FIGS. 4A and 4B, the attenuation poles P1 through P4 of the embodiment, having been moved to the pass-band side of each of the filters farther than the conventional attenuation poles P1' through P4', show the characteristics abruptly blocking the pass-band side of the counterpart filter, respectively. The fluctuation in the pass-band width is small. The amount in which the attenuation pole moves depends on the capacity values of the capacities C2 and C3, in which it has been evident that the larger the value is set, the closer the attenuation pole moves to the pass-band side. The capacities C2 and C3 are appropriately set according to a required characteristic.

As described above, in the antenna duplexer of the embodiment, a position of the attenuation pole is changed to easily obtain the required attenuation characteristic by a simple manner in which the transmission terminal and the reception terminal are extended up onto the position opposing the respective resonance electrodes of the second stage.

In this structure, the coupling relationship and coupling degree between the adjacent resonators is changed by modifying the configuration of step holes forming the resonator holes. Thus, in addition to the advantage of the resonator-length reduction given by the step resonators, there is no need to dispose a hole or a groove for coupling between the resonators, so that the antenna duplexer can be low-cost and compact.

Furthermore, since the open end of each of the resonators is formed in a position recessed from the end face of the dielectric block, the leak from the open end of the electromagnetic field (electromagnetic-field leak) is reduced.

Although the embodiment is described by using the structure in which both the transmission filter and thie reception filter are formed by the resonators of three stages, and two attenuation poles are respectively provided on the pass-band side of the counterpart filter, the structure should not be limited to this case. It is also possible to use a structure in which at least two-stage resonators may form a band pass filter and one ettenuation pole may be respectively provided on the pass-band side of the counterpart filter.

Referring to FIGS. 5A, 5B and 5C, a description will be given of a structure of an antenna duplexer according to a second preferred embodiment of the present invention. Although the resonator holes are disposed in the dielectric block and the inner conductor (resonance electrode) is formed on the inner periphery of each of the resonator hole in the first embodiment, the antenna duplexer shown in FIG. 5 has a structure in which resonance electrodes 32a through 32c as the resonators of the transmission-side filter, resonance electrodes 33a through 33c as the resonators of the reception-side filter, and a resonance electrode 34a for external coupling are disposed in a dielectric substrate 31. In other words, the dielectric substrate is used as an alternative to the dielectric block used in the first embodiment, and each of the resonance electrodes is formed of a strip line, in which the arrangement of the other parts is the same as that in the first embodiment.

Even in the strip-line type antenna duplexer, since each resonator is formed in a step-like configuration having the line widths different at the substantial center and the transmission terminal Tx and the reception terminal Rx are respectively extended onto positions opposing the second-stage resonance electrodes 32b and 33b, the same advantages as those of the antenna duplexer of the first embodiment can be obtained. Moreover, the duplexer can be thinner than that of the first embodiment to make its height lower (to make it thinner).

Although the embodiment has been described by using the structure in which two dielectric substrates are, bonded together or stacked to dispose the resonance electrodes inside the dielectric substrates, it is also possible to use another structure in which each resonance electrode is formed on a dielectric substrate and an outer conductor (a ground electrode) is formed on the opposing surface.

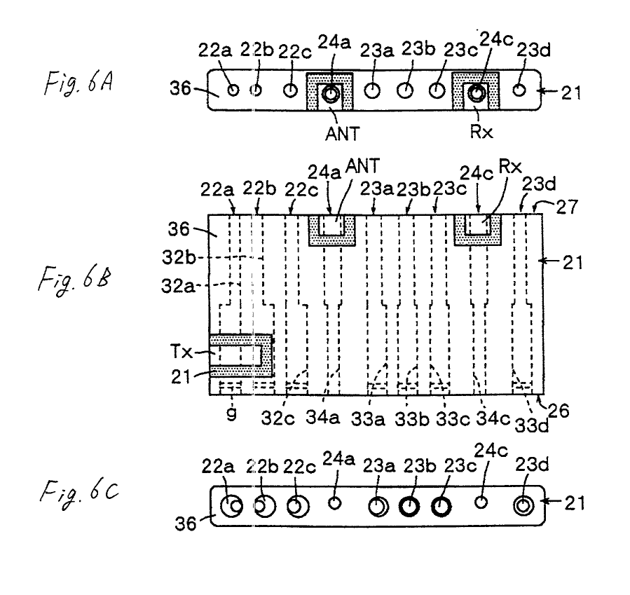

Referring to FIGS. 6A, 6B 6C, a description will be given of a structure of an antenna duplexder according to third embodiment of the present invention. The antenna duplexder of this embodiment is formed by adding a resonator hole 23d for trapping and an external coupling hole 24c for IN/OUT coupling on the reception-filter side of the antenna duplexer of the first embodiment shown in FIG. 1. Inner conductors 33d and 34c as resonance electrodes are formed on the inner periphery of the resonator hole 23d and the external coupling hole 24c. The reception terminal Rx is connected to the inner conductor 34c of the external coupling hole 24c to be formed bar being extended from one of the main surfaces to the second end face 27. An inlerdigital coupling is each made between the inner conductor 34c of the external coupling hole 24c and the adjacent inner conductors 33c and 33d, respectively, whereby the external coupling of the reception filter can be obtained. The arrangement of the other parts is the same as that in the first embodiment, arid the explanations about them are omitted.

In other words, the transmission terminal Tx is formed by being extended to the position opposing the secorid-stage resonance electrode 32b, and the attenuation pole of the transmission filter is moved by the capacity between the transmission terminal Tx and the resonance electrode 32b, so that the attenuation characteristics of the hligher-frequency side are improved. Meanwhile, a trap resonator formed by the resonator electrode 33d is added to the receptionfilter side, so that the attenuation characteristics of the lower-frequency side are improved.

In this arrangement, since the structure of the present invention based on capacitive coupling is applied on Ihe transmission-filter side, the structure can be smaller than the conventional one shown in FIG. 10 (the structure in which a trap resonator is added onto both-filter sides). Furthermore, adding the trap resonator into the structure permits various characteristics to be obtained.

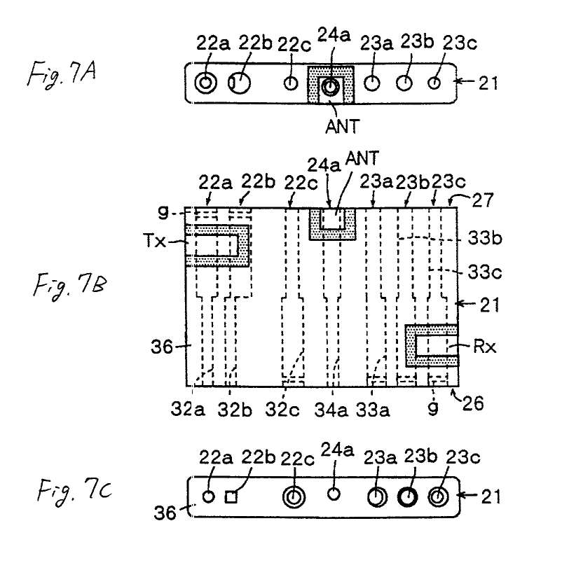

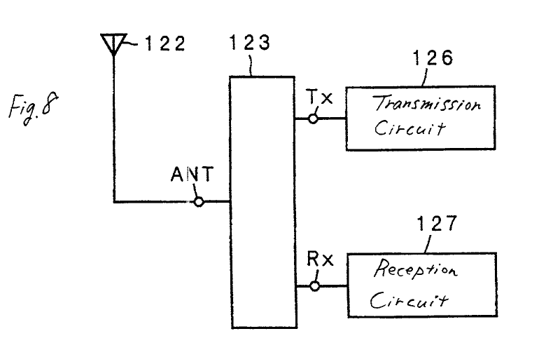

FIGS. 7A, 7B and 7C shows a structure of an antenna duplexer according to a fourth preferred embodiment of the present invention. The antenna duplexer of this embodiment has a structure in which the open ends of the first and second stage resonators of the transmission filter are set on the side where the second end face 27 is present. The basic structure about the other parts is almost the same as that in the first embodiment.

In other words, in this embodiment, the large inner-diameter parts of the respective resonator holes 22a and 22b are formed to be set on the side where the second end face 27 is present, and the non-conductive portions g of the inner conductors 32a and 32b are formed in the proximity of the edge of the side where the second end face 27 is present. An interdigital coupling is made between the resonator formed by the inner conductor 32b and the resonator formed by the inner conductor 32c of the transmission-filter side. The transmission terminal Tx is formed by being extended from one of the main surfaces to the side surface on the side where the second end face 27 is present. In this arrangement, a part of the couplings between the resonators is set to be an interdigital coupling, whereby the freedom in the coupling between the resonators can be facilitated, so that a pitch between the resonators can be wider without modifying the entire outline dimension. Accordingly, Q_{O}. of the resonators can be improved to control the characteristics such as insertion losses.

Additionally, the small inner-diameter part of the resonator hole 22b is formed in a quadrangular-sectionail configuration, in which the small inner-diameter part extends off the large inner-diameter part. The couplings between the adjacent resonators can be adjusted in a wider range by changing the sectional configuration of the step hole and the degree of eccentricity between the small inner-diameter part and the large inner-diameter part. Since the small inner-diameter part is quadrangular-shaped, the angularity at a junction of the small inner-diameter part and the large inner-diameter part can be reduced. Accordingly, the number of acute-angle parts of the shaping die can be decreased and thereby the durability of the die can be enhanced, so that the deterioration of Q_{O} of the resonator can be suppressed.

As described in this embodiment, the integrally-formed compact antenna duplexer with satisfactory characteristics can be manufactured at low cost by combining the method of adjusting the attenuation pole by the capacitive coupling of IN/OUT terminals in accordance with the present invention with the other arrangement.

The antenna duplexer in accordance with the present invention should not be limited to the respective embodiments above, and various modifications can be applied in the range of the scope and the spirits of the present invention. For example, in the respective embodiments above, a description has been made by using the structure in which the open end of each resonator is formed in a position recessed from the end face of the dielectric block or the dielectric substrate. However, the opening surface of the resonator hole may be used as an open end. Moreover, the present invention can be applied in an antenna dupiexer, in which a groove or the like for coupling between the resonators is disposed in the dielectric block.

FIG. 8 shows a structure cf a communication apparatus according to a fifth preferred embodiment of the present invention. In FIG. 8, 122 is an antenna, 123 is an antenna duplexer, 126 is a transmission circuit, and 127 is a reception circuit. An antenna terminal ANT of the antenna duplexer 123 is connected to the antenna 122, a transmission terminal Tx is connected to the transmission circuit 126, and a reception terminal Rx is connected to the reception circuit 127, whereby the communication apparatus is formed.

In this arrangement, as the antenna duplexer 123, the antenna duplexer described in the first through fourth embodiments can be used. Use of the antenna duplexer in accordance with the present invention permits the communication apparatus, which is low-cost, compact, and satisfactory in the characteristics, to be obtained.

While the invention has been particularly shown and described with reference to preferred embodiments thereof, it will be understood by those skilled in the art that the forgoing and other changes in form and details may be made therein without departing from the spirit of the invention.

What is claimed is

1. An.antenna duplexer, comprising:
a plurality of resonance electrodes constituting a transmission filter and a reception filter;
a dielectric member disposed between the resonance electrodes and a ground electrode;
a transmission terminal, a reception terminal, and an antenna terminal, which are separated from the ground electrode in the region where the ground electrode is formed;
at least one of the transmission terminal and the reception terminal provided to make capacitive couplirg between the resonance electrode of a first stage corresponding to an In/Out stage and the resonance electrode of a second stage adjacent to the resonance electrode.

2. The antenna duplexer according to claim 1, wherein the coupling between the resonator of a first stage and the resonator of a second stage forming a filter of a lower frequency is an inductive coupling, and the coupling between the resonator of a first stage and the resonator of a second stage forming a filter of a higher frequency is a capacitive coupling.

3. The antenna duplexer according to claim 1, wherein a trap resonator is added into the In/Out unit of either one of the transmission filter or the reception filter.

4. The antenna duplexer according to claim 1, wherein at least one of the couplings between the resonators is an interdigital coupling.

5. The antenna duplexer according to claim 1, wherein the respective resonance electrodes have a step. like configuration in which the line width is different at a certain point; and the step-like configurations of the resonance electrodes are formed in such a manner that the coupling between the adjacent resonators provides a required value.

6. The antenna duplexer according to claim 5, wherein the narrow part of the line-width of the resonance electrode extends off the wide part of the line-width.

7. The antenna duplexer according to claim 1, wherein the resonance electrode is formed on the inner periphery of a resonator hole disposed inside the dielectric member.

8. The antenna duplexer according to claim 1, wherein the resonance electrode is formed in a strip-line configuration inside the dielectric member or on the dielectric member.

9. The antenna duplexer according to claim 7, wherein at least one resonator hole or a part of the resonator hole is in a quadrangular-sectional configuration.

10. A communication apparatus comprising at least one of the antenna duplexers according to claim 1.
